(19) United States
(12) Patent Application Publication
(10) Pub. No.: US 2006/0277206 A1
(43) Pub. Date: Dec. 7, 2006

(54) Automated reporting of computer system metrics

(76) Inventors: Philip G. Bailey, Wyoming (AU); Barry J. Spies, Stanwell Park (AU); Peter M.W. Poortman, Aukland (NZ)

Correspondence Address: FISH & RICHARDSON P.C., P.O. BOX 1022, MINNEAPOLIS, MN, 55440-1022, US

(21) Appl. No.: 11/143,903

(22) Filed: Jun. 2, 2005

(51) Int. Cl. G06F 7/00

(52) U.S. Cl. 707/102

(57) ABSTRACT

Techniques for reporting computer resource utilization data involve receiving metrics data relating to a computer system that includes multiple resources and identifying, based on the metrics data, resources that are over-utilized and resources that are under-utilized. A summary graphical report of the number of over-utilized resources and the number of under-utilized resources is generated, and a utilization graphical report is generated. The utilization graphical report includes a color-coded listing of over-utilized resources and under-utilized resources and a color-coded indication of utilization for each resource over multiple time periods including one or more predicted utilizations for a future time period. The summary graphical report is displayed, and the utilization graphical report is displayed using a user interface that supports automated manipulation of information in the graphical report in response to a user interaction.

### TECHNICAL FIELD

This description relates to computer system management, and more particularly to automated reporting of computer system metrics.

### BACKGROUND

In large organizations, the number of computers, servers, storage devices, and other digital processing devices can be considerable. The various devices provide an information technology (IT) infrastructure, handle general and specialized software applications, store files and other data, and the like. Different devices can run on different platforms and can be distributed across a wide geographical area. The location, platform type, and functions to be performed by individual devices can influence the efficiency of the overall IT infrastructure.

Management of such an infrastructure typically involves some type of monitoring of system capacity, workload, and other parameters. These parameters typically can be quantified using metrics that relate to one or more system characteristics. The large number of devices can make it difficult to monitor device metrics and manage the devices. Among other things, organizing and reporting metrics effectively can help avoid potential capacity and performance problems in a digital processing environment. For example, it can help identify devices that have or are likely to have demands that exceed processing capacity and/or performance capabilities.

### SUMMARY

Techniques are described for generating reports that summarize and allow convenient access to detailed data relating to utilization of resources in a computer environment.

In one general aspect, metrics data relating to a computer system that includes multiple resources is received. Based on the metrics data, resources that are over-utilized and resources that are under-utilized are identified. A graphical report for the identified resources is generated and displayed using a user interface that supports automated manipulation of information in the graphical report in response to a user interaction.

Implementations can include one or more of the following features. The metrics data measures a performance and/or a utilization relative to a capacity of resources in the computer system. The over-utilized resources and the under-utilized resources are identified by comparing the metrics data for each of the resources with thresholds. The graphical report provides a summary of a number of over-utilized resources and a number of under-utilized resources. The automated manipulation involves generating a graphical report listing each of the over-utilized resources and each of the under-utilized resources. The graphical report listing each of the over-utilized resources and each of the under-utilized resources includes a predicted utilization for each of the resources, and the predicted utilization is displayed for each of multiple consecutive periods. The graphical report listing each of the over-utilized resources and each of the under-utilized resources includes a historical utilization for each of the resources, and the historical utilization is displayed for each of multiple consecutive periods. The predicted utilization is calculated based at least in part on the historical utilization. The graphical report listing each of the over-utilized resources and each of the under-utilized resources includes a first visual indication associated with the over-utilized resources and a second visual indication associated with the under-utilized resources.

The graphical report listing each of the over-utilized resources and each of the under-utilized resources includes a recommended action for each of the over-utilized resources and each of the under-utilized resources. The graphical report includes a link to one or more additional reports relating to the resources in the computer system. The graphical report includes historical utilization information for resources in the computer system. The graphical report lists each of the over-utilized resources and each of the under-utilized resources, and the automated manipulation involves sorting and/or filtering resources listed in the graphical report. The graphical report includes multiple data fields and sorting or filtering of resources listed in the graphical report involves sorting or filtering the listed resources according to data included in the data fields. The metrics data is extracted from one or more databases.

In another general aspect, a graphical report of a utilization level for each of multiple resources in a computer environment and for each of a plurality of time periods is displayed. A user interaction with a user interface is received. Information in the graphical report is sorted and/or filtered in response to the user interaction to generate an updated graphical report, and the updated graphical report is displayed.

The invention can be implemented to realize one or more of the following advantages. Reports concerning performance and capacity in a computer environment can be generated and presented to users. The reports can be used by an enterprise to monitor its own computer systems or, in the case of a computer services enterprise, to monitor client computer systems. In the latter case, the reports can be used to keep one or more clients apprised of the status of their computer systems and to provide advance warning of forecasted demand. The reports can be produced automatically by extracting information from a database in accordance with a periodic schedule or in response to an administrator's trigger. The reports can provide historical and predicted metrics regarding the computer environment and can provide recommended actions for addressing potential utilization inefficiencies or problems. The overall state of an enterprise's computer systems can conveniently be viewed. Reported data can be sorted and filtered according to any type of criteria. Reported data can also be viewed at multiple levels of aggregation. One implementation of the invention provides one or more of the above advantages.

The details of one or more implementations are set forth in the accompanying drawings and the description below. Other features will be apparent from the description and drawings, and from the claims.

### DESCRIPTION OF DRAWINGS

FIG. 1 is a block diagram of a computer system including components for monitoring resource utilization in the system.

FIG. 2 is an illustrative example of a server capacity report displayed in an interactive user interface.

FIG. 3 is an illustrative example of a capacity summary report displayed in an interactive user interface.

FIG. 4 is an illustrative example of an alternative capacity summary report displayed in an interactive user interface.

FIG. 5 is an illustrative example of a current utilization summary report displayed in an interactive user interface.

FIG. 6 is an illustrative example of a performance red flag list report displayed in an interactive user interface.

FIG. 7 is an illustrative example of a capacity recommendations list report displayed in an interactive user interface.

FIG. 8 is an illustrative example of a resource utilization history report displayed in a user interface.

FIG. 9 is an illustrative example of an aggregated CPU utilization history report displayed in a user interface.

FIG. 10 is an illustrative example of a CPU historical utilization breakdown report displayed in a user interface.

FIG. 11 is an illustrative example of an aggregated disk historical utilization report displayed in a user interface.

FIG. 12 is a flow diagram of a computer environment utilization reporting process.

Like reference symbols in the various drawings indicate like elements.

### DETAILED DESCRIPTION

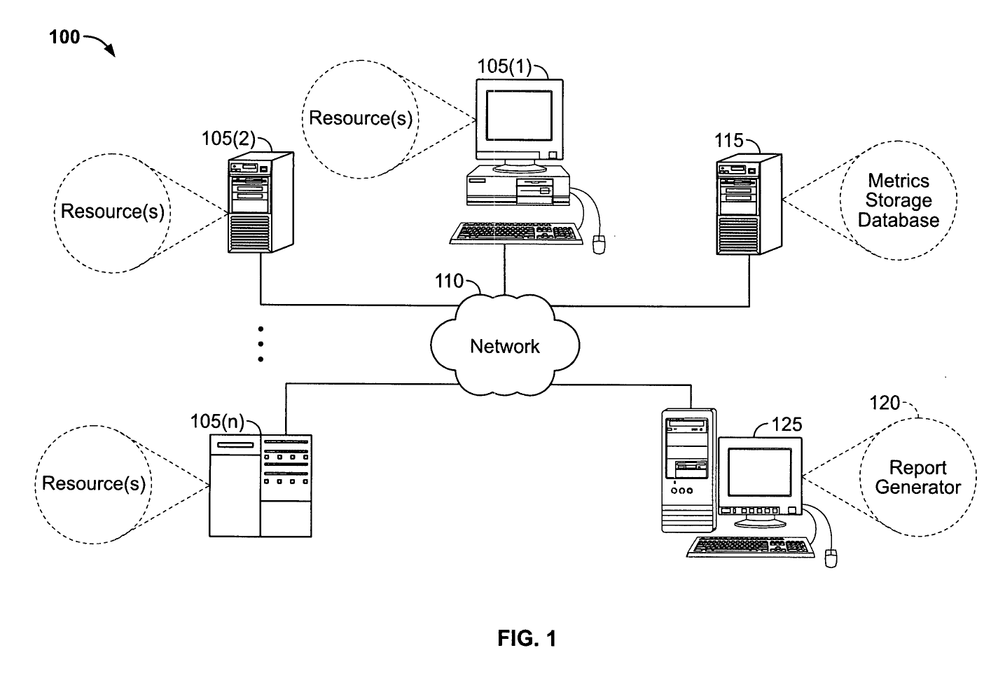

FIG. 1 is a block diagram of a computer system 100 including components for monitoring resource utilization in the system. The computer system 100 includes a large number of devices 105(1), 105(2), . . . , 105(n) (collectively or individually, devices 105), where n>>1 (e.g., n=1000 or n=10,000). The devices 105 can include servers, disks, memories, digital processors, software applications, software utilities, and other computer-related hardware and/or software resources. For purposes of this description, a resource can include a device itself, a process, an application, data, or any other resource that facilitates the operation of the computer system 100. The devices 105 can perform many different functions. For example, the devices 105 can service many different entities within an overall enterprise and can provide digital storage space, application processing, and/or general network management functions. The devices 105 can be located in a single location or distributed across a wide geographical area (e.g., worldwide). The devices 105 can include a variety of different platforms (e.g., Unix, Intel, AS400, Linux, Tandem, and VMS).

Different devices 105 can have different capacity and performance characteristics. For example, different devices 105 can have different storage capacities and/or different nominal processing rates. In general, capacity metrics measure volume-based characteristics (e.g., used disk space as a percentage of available disk space), and performance metrics measure rates at which task are performed (e.g., an input/output rate). Another type of metric is a business metric, which, for example, is a ratio of transactions to performance or capacity metrics. The metrics can be a simple measurement or a normalized value (e.g., as a percentage of a maximum or nominal value). In general, normalized values enable more convenient comparisons between data for different devices, particularly where different devices have different maximum or nominal capacity and performance characteristics. Metrics can be collected and calculated using any type of algorithm or process, such as the techniques for collecting computer resource utilization data described in U.S. patent application Ser. No. 10/259,786, entitled “Generation of Computer Resource Utilization Data per Computer Application,” filed Sep. 30, 2002.

In general, devices 105 interact with one another across a network 110, which can include a private network, a public network, a local area network, a wide area network, a telecommunication network, and/or any other types of networks capable of communicating data. For example, the data resulting from processing by an application on one device 105 can be transmitted to and stored on disk space on another device 105. Each device can include a utility for collecting and/or calculating statistics such as capacity and performance metrics. Such metrics can be stored locally on the device 105 itself and/or can be transferred through the network 110 to one or more central databases 115 for storage of the metrics. The metrics can be collected during successive intervals and stored at the end of each interval.

A report generator 120 can periodically retrieve (e.g., by sending a request and receiving in response to the request) metrics data from the databases 115 of from the devices 105 themselves at a period that matches or is different from the intervals. The report generator can be implemented as software on a server or computer 125. The report generator 120 can process and/or aggregate the metrics data to generate reports that facilitate performance management and capacity planning for the overall computer system 100. The report can show resource utilization and forecast views for all the devices 105. The different views can be organized in a hierarchy such that some views present data in a relatively aggregated manner while other views present data in a more detailed manner.

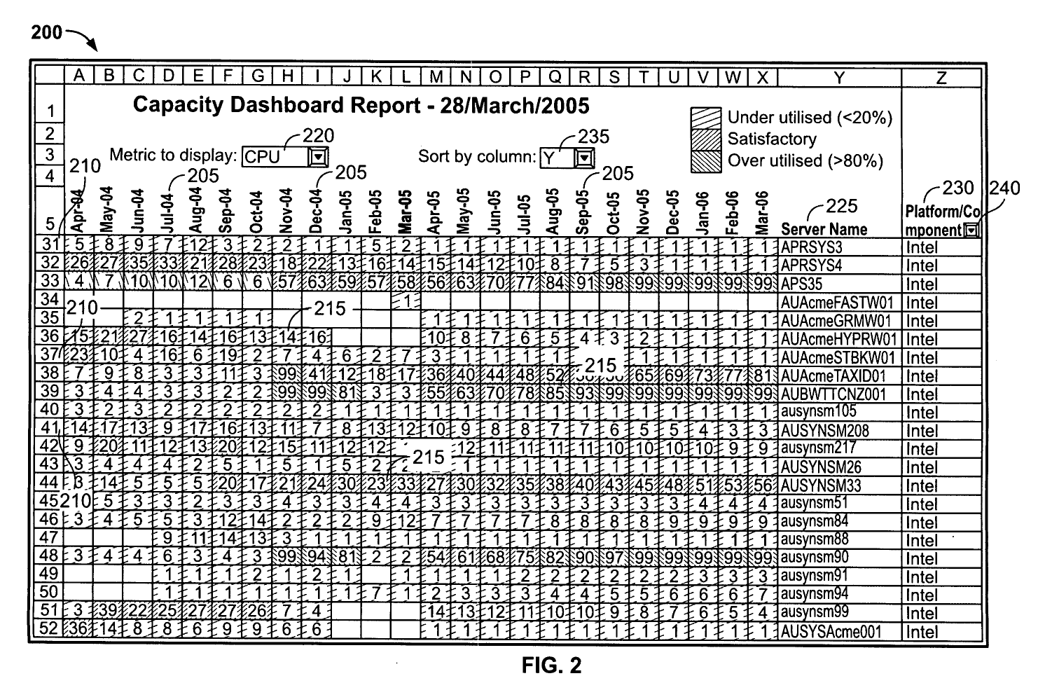

FIG. 2 is an illustrative example of a server capacity report 200 displayed in an interactive user interface. The report 200 includes a twelve month history and a twelve month forecast of central processing unit (CPU) utilization metric for all monitored servers or other devices. Each column 205 corresponds to a monthly time period and each row 210 corresponds to a different server. Thus, each entry 215 corresponds to a CPU utilization metric for a particular server during a particular month. Although the illustrated example uses a twelve month history and a twelve month forecast and monthly intervals, reports can include different historical and forecasted durations and each column 205 can correspond to any interval (e.g., hours, minutes, seconds, days, or years), and the historical values can use different intervals or durations relative to the forecast. In some implementations, each column 205 can correspond to a different time period, and/or each row 210 can correspond to a group of devices, different types of devices, or resources within devices. In addition, the report 200 can be changed using a drop down menu 220 to display other types of metrics, such as memory utilization or disk utilization, which may be contained in either the same or separate set of data and for which the view is obtained using available spreadsheet or other programming languages or tools to switch from one view to another. Utilization can include aspects of performance, capacity, and/or business considerations.

In the illustrated example, the CPU utilization metrics displayed in entries 215 are measured in terms of a percentage of maximum capacity. Utilization and performance metrics can also be measured in terms of raw data, excessive paging rates (e.g., to detect memory over-utilization), or using quantization factors. In some implementations, utilization metrics are based on averages of the maximum hourly average per day during business hours (e.g. 9 am to 6 pm). The “hourly average per day during business hours” is the average utilization over an hour (for each hour across a business day). Utilization corresponds to durations when computer CPUs are either busy or not, and on or off “states” can be measured in nanoseconds. The “maximum hourly average per day during business hours” is the maximum of all the hourly averages in a set of observations (e.g., over a business day). The “averages of the maximum hourly averages per day during business hours” is the average of each of the maximum daily hourly averages for all business days (e.g., across a month). The monthly values are derived by various computations. In general, capacity planning attempts to determine what equipment is required without catering for unusual events. One technique is to compute and average of the daily maximums for the month to arrive at a figure, which, while not being the maximum value for the month, is near it and will generally meet the computing requirements on most occasions. Depending on the perceived requirements capacity planners typically use maximums of averages, averages of maximums, maximums of maximums, or various other percentiles.

The entries 215 are color coded (e.g., yellow for under-utilized, red for over-utilized, or green for within a target utilization range) based on whether the corresponding metric for each entry 215 is under a first threshold (e.g., twenty percent), over a second threshold (e.g., eighty percent), or between the first and second thresholds (e.g., between twenty and eighty percent). In some systems or platforms, there may be limitations on the ability to detect under-utilization of memory, for example. In such a case, the reports may focus on over-utilization.

As an alternative to color coding the entries 215, other visual indications, such as shapes and/or symbols and/or fonts and/or boldness and/or brightness and/or background designs, can be used to indicate resource utilization levels. Accordingly, users can conveniently identify which servers, other devices, and/or resources have excess capacity or are being over-utilized. This information can be used to, among other things, identify candidate devices or other resources between which utilization demands can be merged or transferred. For example, it may be possible to off-load processing performed by one server that is over-utilized to another server that is under-utilized. Alternatively, utilization of under-utilized disk space on two nearby devices can be merged so that one of the devices can be moved to a new location to handle overflow demand.

The historical utilization metrics are based on data from prior collection periods, which can be stored for later use or reference. The forecasted or predicted utilization metrics can be predicted based on a forecasting algorithm that accounts for, for example, projected growth rates, planned additions of resources, historical trends and patterns, and the like. In one implementation, forecasts can be calculated by first determining the first and last months for which there is valid data (e.g., for a particular metric), dividing this range of months in half, averaging the data for all months in the first half, and averaging the data for all months in the second half. Using the two averages, a monthly rate of increase or decrease is calculated, and the utilization for the next twelve months is forecasted by extrapolating the rate of increase or decrease from the last month that contained valid data and/or starting at the value of the second half average. Other forecasting algorithms can also be used.

As illustrated, the server capacity report 200 includes a column 225 listing various servers, with each row providing utilization metrics for the corresponding server. One or more additional columns 230 include data fields containing data relating to other characteristics, attributes, or parameters associated with each server. For example, the server capacity report 200 can include additional columns 230 for identifying a platform/component, company, entity, department, business unit, industry, contract, region, country, city, address, production environment, application, category, function, description, priority level, ownership, billing status, operating system, hardware, hardware category, size, number of CPUs, processing speed (e.g., in MHz), memory size (e.g., in Mbytes), disk size (e.g., in Gbytes), and/or any other information or data associated with the server or other device. For some servers or devices in the list, some data fields may be inapplicable (or unavailable) and therefore blank.

The listing of servers can be sorted according to the data in any of the monthly time period columns 205 or in any one of the additional data field columns 230 (e.g., using a sorting tool 235 that includes a drop-down menu of sorting options). In addition, the listing of servers can be filtered according to the data in one or more of the monthly time period columns 205 and the additional data field columns 230 (e.g., using a filtering tool 240 that includes a drop-down menu of filtering options). The interactive sorting and filtering functions can make the server capacity report 200 more useful and flexible because, for instance, different users with different focuses or concerns can filter and/or sort the data to provide convenient viewing of the utilization data that is most relevant to those individuals based on their responsibilities. The filtering capabilities can also be used to limit the amount of information that is contained in a report (i.e., before the report is delivered) based, for example, on the audience. If the report 200 is produced by a computer services enterprise for use by a client, the report 200 is generally limited to that client's devices and resources and may not include more technical reporting aspects. The same computer services enterprise may produce internal reports 200 that do not include such restrictions.

The server capacity report 200 can be populated with data automatically (e.g., according to a predefined periodic schedule) or in response to an administrator request. In addition, the server capacity report 200 can be updated automatically. For example, the data in the report can be updated daily even though each report entry 215 encompasses an entire month (although it could also encompass individual hours or days). Thus, each day the data for the current month, and the forecasted data can change based on daily utilization or performance variations.

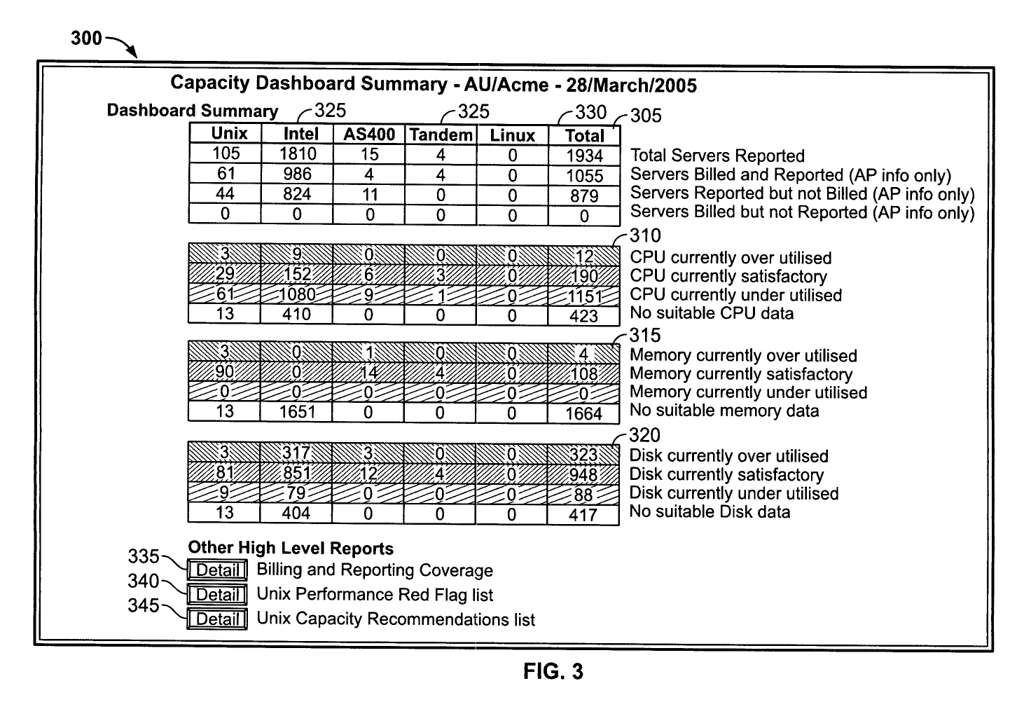

FIG. 3 is an illustrative example of a capacity summary report 300 displayed in an interactive user interface. The data from the capacity summary report 200 or from metrics stored in a central database 115 or on local devices 105 (see FIG. 1) can be aggregated to provide summary information for the capacity summary report 300. Data can be aggregated according to any desired criteria. In general, the summary data specifies a number of servers, other devices, or resources that meet certain criteria and/or that fall into a particular category. In the illustrated example, the capacity summary report 300 includes a billed and reported aggregation chart 305, a CPU utilization chart 310, a memory utilization chart 315, and a disk utilization chart 320. Charts for aggregating data based on other criteria and/or categories can also be used.

Each chart 305, 310, 315, and 320 includes columns 325 corresponding to different platform types and a column 330 for a total number of servers. The billed and reported aggregation chart 305 includes rows for a total number of servers reported, servers billed and reported, servers reported but not billed, and servers billed but not reported. In this example, the servers are being reported by a computer services enterprise that bills based on a number of servers managed, for example. Each entry corresponds to the data for the intersection of the column and row criteria. The CPU utilization chart 310 includes rows for a number of CPUs currently over-utilized, a number of CPUs currently having a satisfactory utilization, a number of CPUs currently under-utilized, and a number of CPUs for which there is insufficient data. The memory utilization chart 315 includes rows for a number of memories currently over-utilized, a number of memories currently having a satisfactory utilization, a number of memories currently under-utilized, and a number of memories for which there is insufficient data. The disk utilization chart 315 includes rows for a number of disks currently over-utilized, a number of disks currently having a satisfactory utilization, a number of disks currently under-utilized, and a number of disks for which there is insufficient data. Color coding for the different utilization levels can also be used in the capacity summary report 300.

The capacity summary report 300 can also include other high-level reports or links to other high-level reports. In this example, the capacity summary report 300 includes a link 335 to a billing and reporting coverage report, which provides details of which servers are billed and/or reported; a link 340 to a Unix performance red flag list, which provides details of which Unix-based servers are over-utilized in some manner; and a link 345 to a Unix capacity recommendations list, which provides recommended actions for some or all of the Unix-based servers. Other high-level reports, charts, and graphs or links thereto can also be included in the capacity summary report 300.

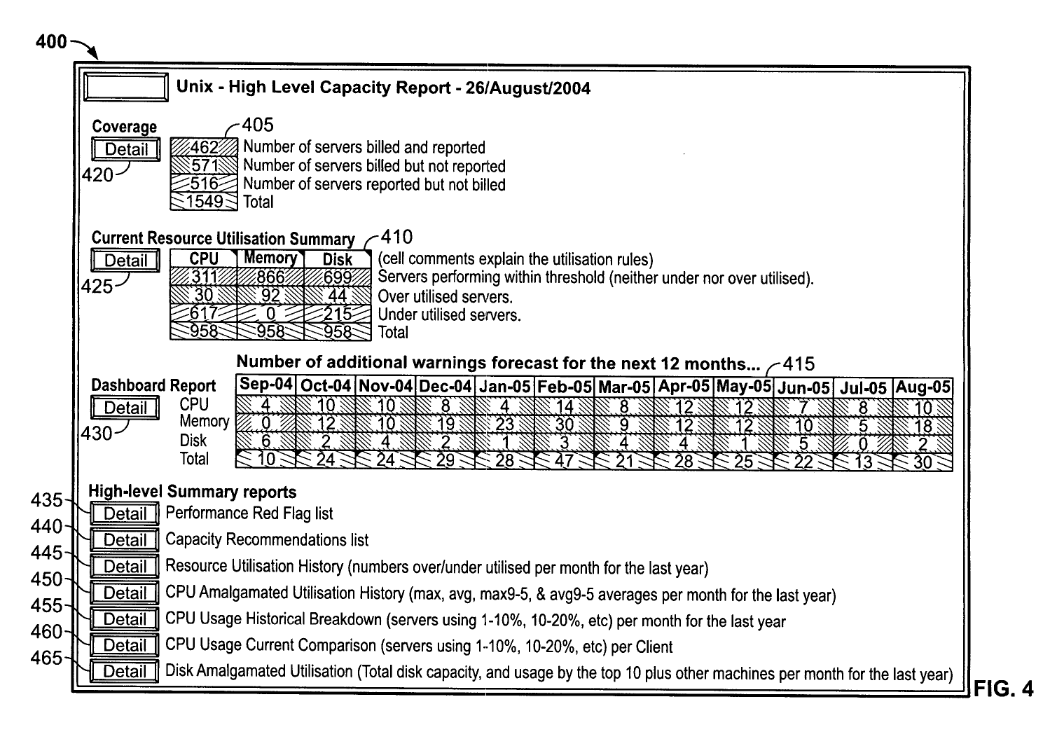

FIG. 4 is an illustrative example of an alternative capacity summary report 400 displayed in an interactive user interface. The alternative capacity summary report 400 includes a coverage chart 405 identifying numbers of billed and reported servers, a resource utilization chart 410, and a warning forecast chart 415. A link 420 to a detailed coverage report provides access to a detail listing of which servers are billed and/or reported.

The resource utilization chart 410 presents summary CPU, memory, and disk utilization data but does not provide a breakdown by platform type. In addition, in this example, CPU under-utilization means that the CPU average utilization during weekday working hours for both the last six months and the last month is less than thirty percent (30%), and CPU over-utilization means that the CPU average utilization during weekday working hours for the last month is greater than eighty percent (80%). In this example, it is not possible to reliably determine low physical memory utilization, and memory over-utilization is determined if memory swapping has occurred in the last month. For disk utilization numbers, disk under-utilization is determined if the current combined file system total storage is greater than 50 gigabytes (GB) and the current combined file system utilization is less than fifty percent (50%), and disk over-utilization is determined if the current combined file system utilization is greater than eighty percent (80%). A link 425 to a detailed current resource utilization report provides access to information relating to which servers include under- and/or over-utilized resources.

The warning forecast chart 415 identifies a forecasted number of CPU, memory, disk, and aggregate warnings (i.e., relating to over- and/or under-utilization conditions) for each of the next twelve months. A link 430 to a detailed report provides access to a corresponding server capacity report (e.g., similar to the server capacity report 200 of FIG. 2). The sample report shows how links to various reports can either be incorporated into a “Capacity Dashboard.” As an alternative or in addition, “thumbnail” copies of various reports can be included in the Capacity Dashboard so that users of the report can have a visual reminder of what other reports are available and can be requested separately. The alternative capacity summary report 400 includes links to other high-level reports, including a performance red flag list 435, a capacity recommendations list 440, a resource utilization history 445, an aggregated CPU utilization history 450, a CPU usage historical breakdown 455, a CPU current usage by client comparison 460, and an aggregated disk utilization history 465.

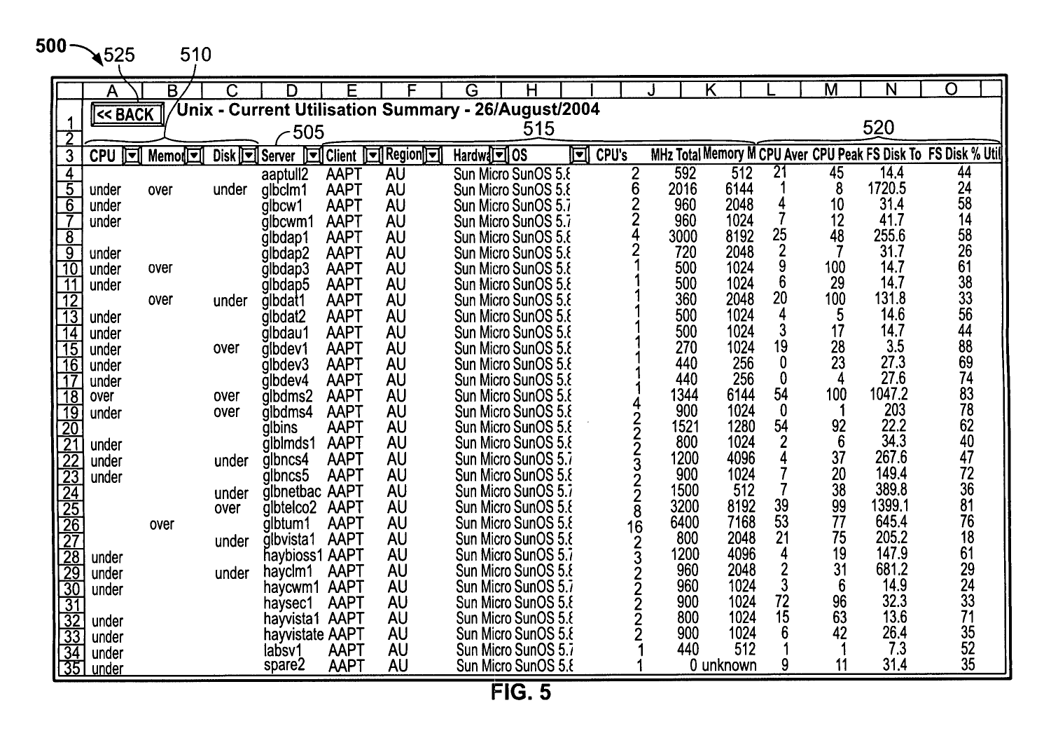

FIG. 5 is an illustrative example of a current utilization summary report 500 displayed in an interactive user interface. The current utilization summary report 500 can be accessed, for example, using the link 425 of FIG. 4. The current utilization summary report 500 includes a column 505 listing servers (e.g., all servers or only servers that are under- or over-utilized), columns 510 indicating whether various resources (e.g., CPU, memory, and disk) for each server are under- or over-utilized, columns 515 listing other attributes of each server, and columns 520 listing relevant statistics or metrics for each server. The other attributes of the servers listed in columns 515 can include which client the server belongs to, a region the server is located in, and the server hardware, operating system, number of CPUs, total MHz, and memory in megabytes. The relevant statistics or metrics in columns 520 can include the average CPU utilization, the peak CPU utilization, the total file system disk space available (e.g., in gigabytes), and the percent utilization of the available file system disk space or other computed metrics. Each of the various columns 505, 510, 515, and 520 include sorting and/or filtering tools analogous to those shown in and described in connection with FIG. 2. A “back” link 525 can be used to return to the alternative capacity summary report 400 of FIG. 4.

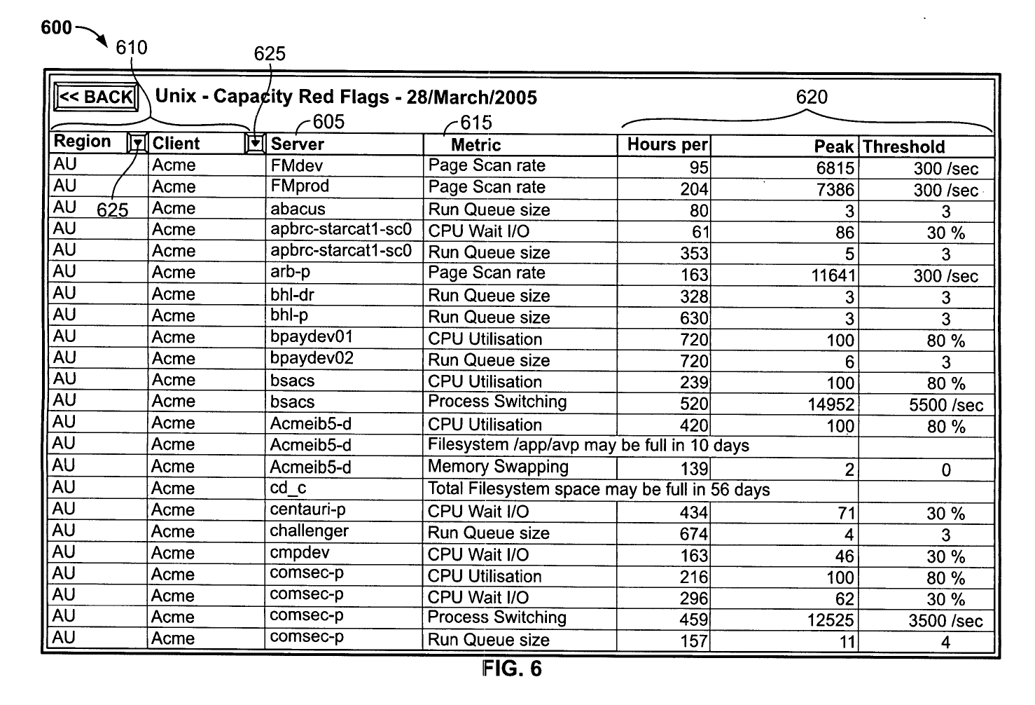

FIG. 6 is an illustrative example of a performance red flag list report 600 displayed in an interactive user interface. The performance red flag list report 600 can be accessed, for example, using the performance red flag list link 435 of FIG. 4 or the link 340 to a Unix performance red flag list report of FIG. 3. The performance red flag list report 600 includes a column 605 listing the servers having performance or capacity red flags, columns 610 listing other attributes of the servers (e.g., region and client), a column 615 identifying a metric that forms the basis for a red flag, and columns 620 listing statistics (e.g., hours of utilization per thirty days, peak utilization, and threshold utilization level above which the resource is over-utilized) associated with the red flag metric. In general, a red flag indicates that the server is over-utilized, and which metric forms the basis for the red flag indicates what aspect of the server is over-utilized. Servers can be listed more than once if red flags are associated with multiple metrics. The metrics can measure numerous different performance or capacity characteristics, including, for example, page scan rate, run queue size, CPU input/output (I/O) wait, CPU utilization, process switching, and memory swapping. Sorting and filtering tools 625 can be provided for one or more of the columns 605, 610, 615, and 620.

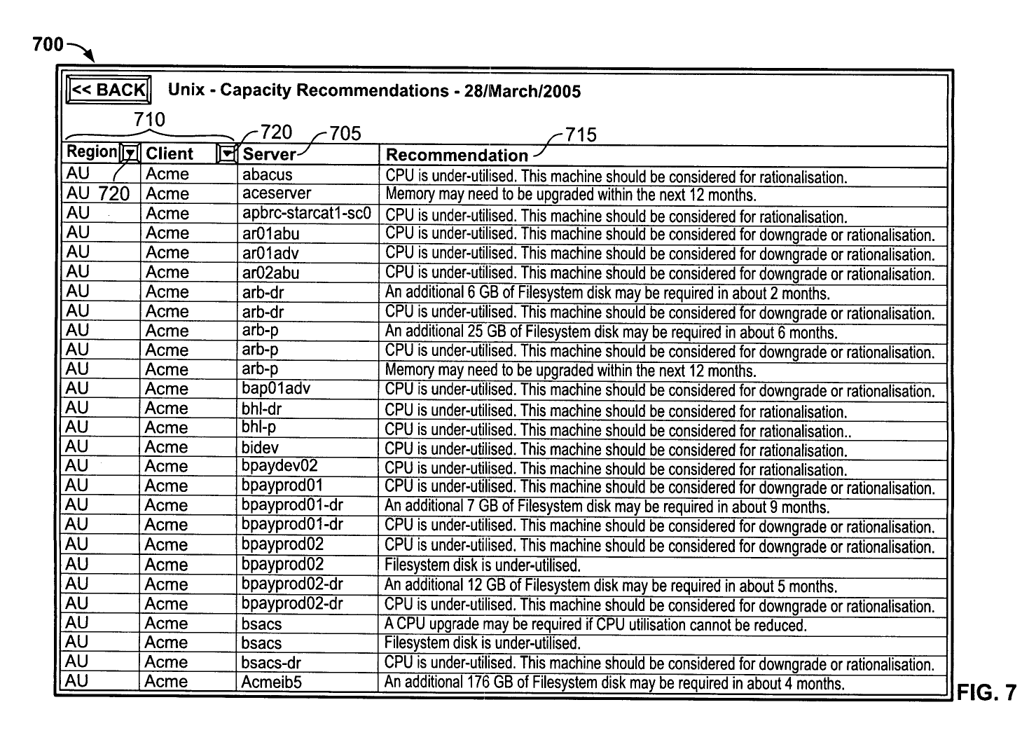

FIG. 7 is an illustrative example of a capacity recommendations list report 700 displayed in an interactive user interface. The capacity recommendations list report 700 can be accessed, for example, using the capacity recommendations list link 440 of FIG. 4 or the link 345 to a Unix capacity recommendations list of FIG. 3. The capacity recommendations list report 700 includes a column 705 listing servers having associated recommendations, columns 710 listing other attributes of the servers (e.g., region and client), and a column 715 providing a recommendation. The recommendations can be generated automatically in accordance with one or more predefined algorithms, semi-automatically using a combination of predefined algorithms and user input and/or modifications to the results of the algorithms, or manually. Servers that have associated recommendations generally include servers that have over- or under-utilized resources. Servers can be listed more than once if multiple recommendations are associated with particular servers. Sorting and filtering tools 720 can be provided for one or more of the columns 705, 710, and 715.

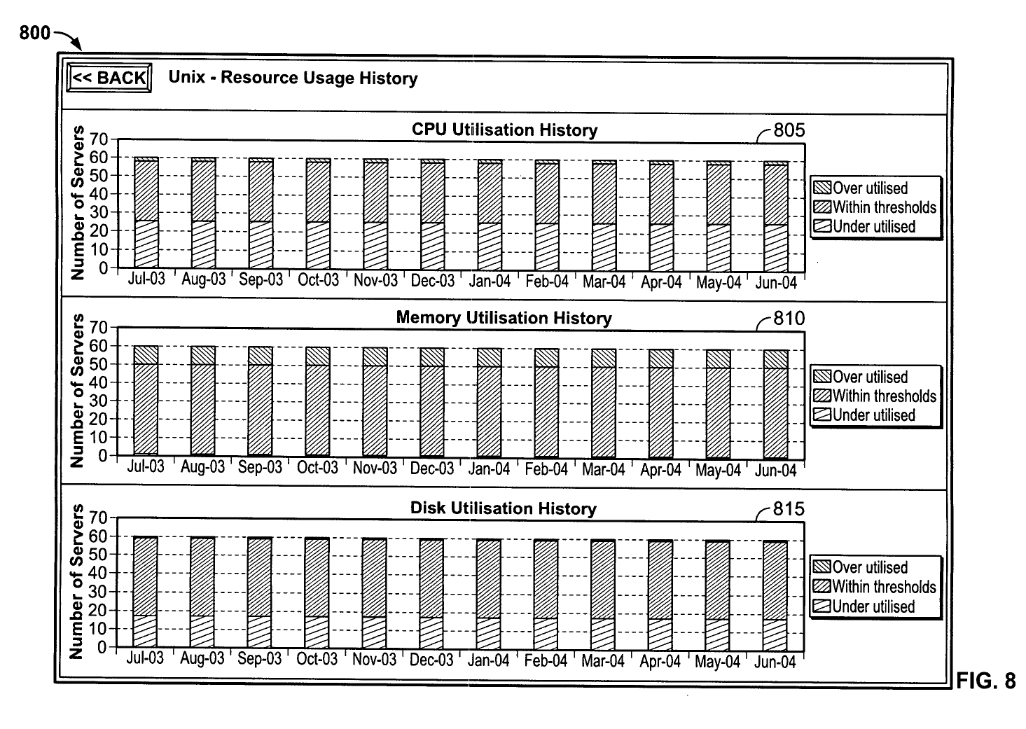

FIG. 8 is an illustrative example of a resource utilization history report 800 displayed in a user interface. The resource utilization history report 800 can be accessed, for example, using the resource utilization history link 445 of FIG. 4. The resource utilization history report 800 includes a CPU utilization history bar chart 805, a memory utilization history bar chart 810, and a disk utilization history bar chart 815, each of which shows historical month-by-month number of servers with different resource utilization levels. The utilization levels are categorized according to servers with over-utilized resources, under-utilized resources, and resource utilization within thresholds. Although the total number of servers in the illustrated example is constant, the total numbers can change as servers are added or removed from service. In addition, the distribution between over-utilization, under-utilization, and utilization within thresholds can have greater or lesser variations over time.

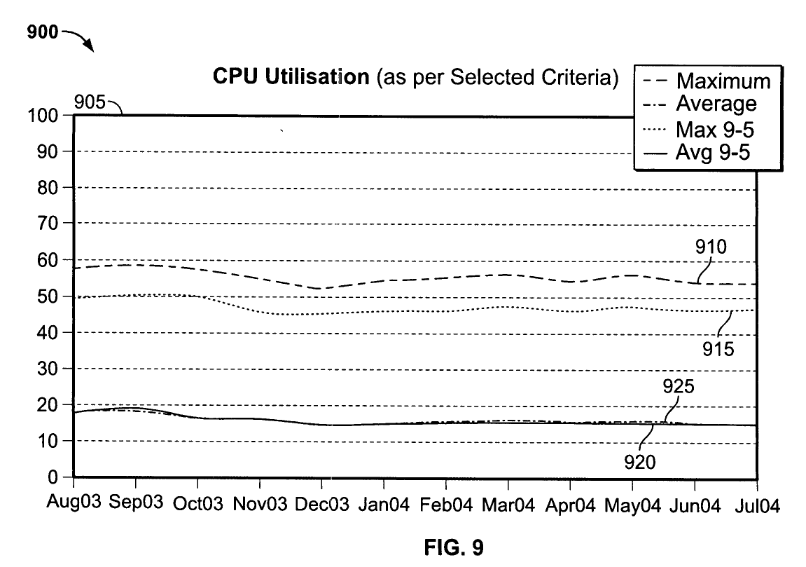

FIG. 9 is an illustrative example of an aggregated CPU utilization history report 900 displayed in a user interface. The aggregated CPU utilization history report 900 can be accessed, for example, using the aggregated CPU utilization history link 450 of FIG. 4. The aggregated CPU utilization history report 900 includes a CPU utilization history line graph 905 showing utilization levels across a twelve month period. Separate lines indicate a maximum utilization level 910, a maximum utilization level during working hours 915, an average utilization level 920, and an average utilization level during working hours 925.

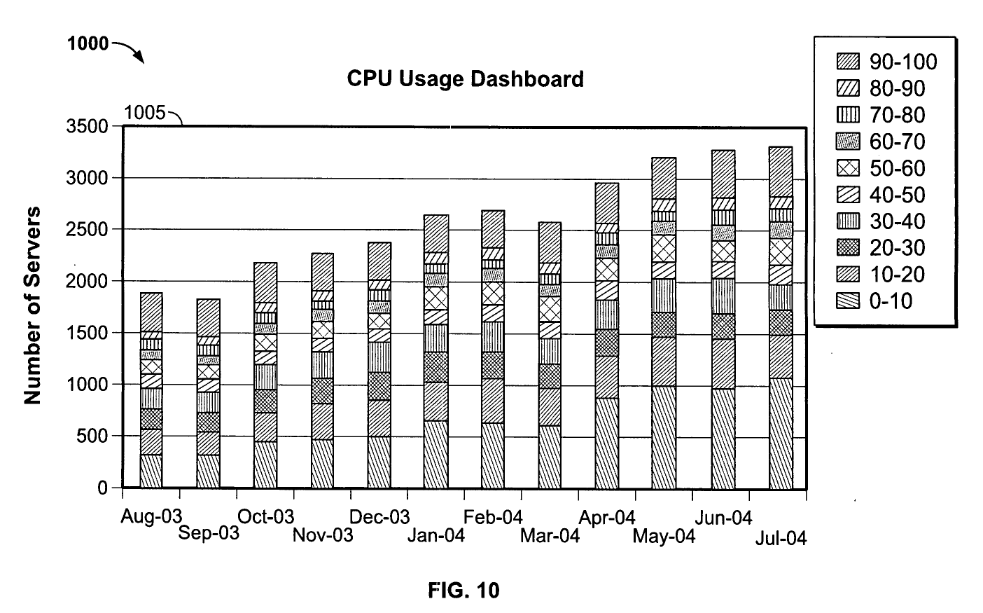

FIG. 10 is an illustrative example of a CPU historical utilization breakdown report 1000 displayed in a user interface. The CPU historical utilization breakdown report 1000 can be accessed, for example, using the CPU usage historical breakdown link 455 of FIG. 4. The CPU historical utilization breakdown report 1000 includes a CPU historical utilization breakdown bar chart 1005 that shows historical month-by-month number of servers with different resource utilization levels. The utilization levels are categorized according to servers in each successive ten percent range of utilization (e.g., 0-10%, 10-20%, 20-30%, and so on). A similar report/chart showing current resource utilization levels by client, rather than showing historical resource utilization levels by month, can be displayed in a user interface using the CPU current usage by client comparison link 460 of FIG. 4.

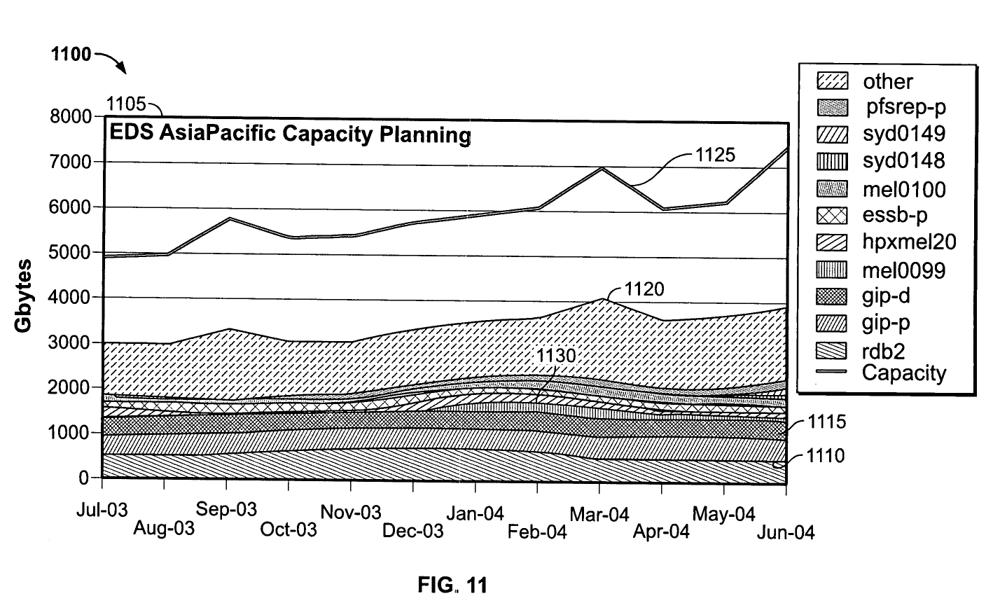

FIG. 11 is an illustrative example of an aggregated disk historical utilization report 1100 displayed in a user interface. The aggregated disk historical utilization report 1100 can be accessed, for example, using the aggregated disk utilization history link 465 of FIG. 4. The aggregated disk historical utilization report 1100 includes a disk utilization history area chart 1105 showing cumulative utilization levels across a twelve month period separately for each of the ten most utilized file systems and combining all remaining file systems into one grouping. Thus, a first line 1110 shows a disk utilization level (in gigabytes) for the most utilized file system, a second line 1115 shows the cumulative disk utilization level for the first and second most utilized file system, and so on. An eleventh line 1120 shows the cumulative disk utilization level for all file systems. Another line 1125 shows the total disk capacity of all file systems in one or more computer environments. The utilization level rank can be determined based on the average utilization across the entire twelve month period. As a result, in this example, although one file system does not have any utilization at the end of the twelve month period, that file system included sufficient disk utilization at other times in the twelve month period (as indicated at 1130) to be included in the top ten.

The various reports shown in FIGS. 2-11 can be implemented using a spreadsheet software application, such as Microsoft Excel. Data can be automatically or manually imported into a spreadsheet framework or template to produce the reports and/or updates to the reports. The reports can be included on different worksheets, which can be accessible using separate tabs or using a drill-down or linking technique (e.g., using a link to a detailed report, such as the link 335 of FIG. 3, and a “back” link in each detailed report, such as the “back” link 525 of FIG. 5). In any event, data from one or more of the worksheets can be processed and/or aggregated to provide data for another worksheet. Accordingly, one or multiple cross-references can be included in the worksheets.

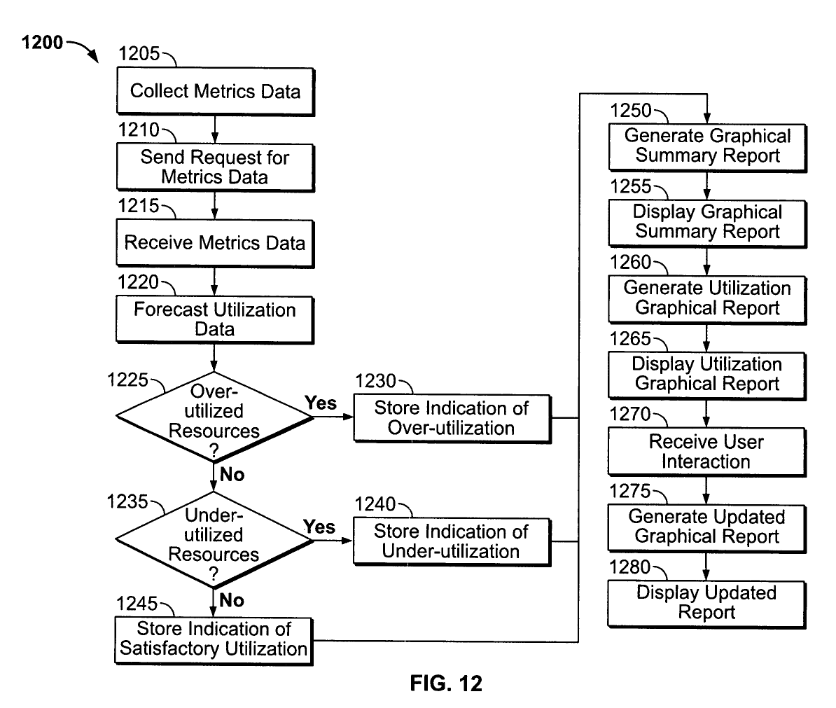

FIG. 12 is a flow diagram of a computer environment utilization reporting process 1200. Metrics data is collected (1205) during normal operations of devices and resources in the computer environment. In general, the metrics data relates to various utilization characteristics of resources in the computer environment. A request is sent (1210) for the metrics data, and, in response, the metrics data is received (1215). The request can be sent and the response can be received by a report generator. The retrieved metrics data, along with historical metrics data, is used to forecast or predict utilization levels (1220) for one or more future time periods.

A determination is made (1225) as to whether the metrics data for each device and/or resource and for each time period indicates one or more over-utilized resources by comparing the metrics data against an upper threshold. If so, an indication that the device and/or resource is over-utilized is stored (1230). Otherwise, a determination is made (1235) as to whether the metrics data for each device and/or resource indicates one or more under-utilized resources by comparing the metrics data against a lower threshold. If so, an indication that the device and/or resource is under-utilized is stored (1240). Otherwise, an indication that the device and/or resource is utilized within the thresholds is stored (1245).

A graphical summary report is generated based on the stored utilization indication data (1250). The graphical summary report can be a primarily textual presentation of data (e.g., textual data organized in columns and rows) or a diagram. In either case, different colors or other distinguishing features can be used to distinguish between different types or categories of data, different devices and/or resources, and different utilization levels. In general, the graphical summary report presents aggregated data (e.g., numbers of over- and under-utilized resources) relating to the computer environment. The graphical summary report is displayed (1255) on a user interface that supports automated manipulation of information in the graphical summary report in response to a user interaction. For example, manipulation of information can include generating a detailed graphical report listing each of the over-utilized resources and each of the under-utilized resources.

A utilization graphical report is also generated (1260). The utilization graphical report lists the over-utilized and under-utilized resources and includes both historical and forecasted utilization levels or metrics for each of the resources. The utilization graphical report can also include visual (e.g., color-coded) indications of which resources are under-utilized and which resources are over-utilized for each time period. The utilization graphical report is displayed (1265) on a user interface that supports automated manipulation of information in the graphical summary report in response to a user interaction. For example, a user can select sort or filter parameters, and the user interface can generate, using the parameters, an updated report for display. A user interaction with the user interface is received (1270). In response, information in the utilization graphical report is sorted or filtered to generate an updated graphical report (1275), and the updated graphical report is displayed (1280).

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, the processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made. For example, user interfaces other than those depicted can be used to present data in accordance with the invention. In addition, the invention can be implemented in systems other than that illustrated in FIG. 1. Moreover, steps shown in and described in connection with FIG. 12 can be performed in a different order or in parallel. Accordingly, other implementations are within the scope of the following claims.

What is claimed is:

1. An article comprising a machine-readable medium storing instructions for causing data processing apparatus to:
receive metrics data relating to a computer system, the computer system including a plurality of resources;
identify, based on the metrics data, resources that are over-utilized and resources that are under-utilized;
generate a graphical report for the identified resources; and
display the graphical report using a user interface that supports automated manipulation of information in the graphical report in response to a user interaction.

2. The article of claim 1 wherein the metrics data measures at least one of a performance or a utilization relative to capacity of resources in the computer system.

3. The article of claim 2 wherein the over-utilized resources and the under-utilized resources are identified by comparing the metrics data for each of the plurality of resources with thresholds.

4. The article of claim 2 wherein the graphical report provides a summary of a number of over-utilized resources and a number of under-utilized resources.

5. The article of claim 4 wherein the automated manipulation comprises generating a graphical report listing each of the over-utilized resources and each of the under-utilized resources.

6. The article of claim 5 wherein the graphical report listing each of the over-utilized resources and each of the under-utilized resources includes a predicted utilization for each of the plurality of resources, the predicted utilization displayed for each of a plurality of consecutive periods.

7. The article of claim 6 wherein the graphical report listing each of the over-utilized resources and each of the under-utilized resources includes a historical utilization for each of the plurality of resources, the historical utilization displayed for each of a plurality of consecutive periods.

8. The article of claim 7 wherein the machine-readable medium stores instructions for causing data processing apparatus to further calculate the predicted utilization based at least in part on the historical utilization.

9. The article of claim 7 wherein the graphical report listing each of the over-utilized resources and each of the under-utilized resources includes a first visual indication associated with each of the over-utilized resources and a second visual indication associated with each of the under-utilized resources.

10. The article of claim 5 wherein the graphical report listing each of the over-utilized resources and each of the under-utilized resources includes a recommended action for each of the over-utilized resources and each of the under-utilized resources.

11. The article of claim 4 wherein the graphical report includes a link to at least one additional report relating to the resources in the computer system.

12. The article of claim 4 wherein the graphical report includes historical utilization information for resources in the computer system.

13. The article of claim 2 wherein the graphical report lists each of the over-utilized resources and each of the under-utilized resources and the automated manipulation comprises at least one of sorting or filtering resources listed in the graphical report.

14. The article of claim 13 wherein the graphical report includes a plurality of data fields and sorting or filtering of resources listed in the graphical report comprises sorting or filtering the listed resources according to data included in the data fields.

15. The article of claim 2 wherein the machine-readable medium stores instructions for causing data processing apparatus to further extract the metrics data from at least one database.

16. A method for providing a utilization report relating to a computer environment, the method comprising:
displaying a graphical report of a utilization level for each of a plurality of resources in a computer environment and for each of a plurality of time periods;
receiving a user interaction with a user interface;
sorting or filtering information in the graphical report in response to the user interaction to generate an updated graphical report; and
displaying the updated graphical report.

17. The method of claim 16 wherein the utilization level relates to at least one of a capacity or a performance of each resource.

18. The method of claim 16 wherein the graphical report comprises a visual indication of one of an over-utilization or an under-utilization for at least some of the plurality of resources.

19. The method of claim 16 wherein sorting or filtering data is performed across at least one of a plurality of data dimensions, each of the plurality of time periods comprising a data dimension and the plurality of data dimensions including at least one other data element.

20. An article comprising a machine-readable medium storing instructions for causing data processing apparatus to:
receive metrics data relating to a computer system, the computer system including a plurality of resources;
identify, based on the metrics data, resources that are over-utilized and resources that are under-utilized;
generate a summary graphical report of the number of over-utilized resources and the number of under-utilized resources;
generate a utilization graphical report including a color-coded listing of over-utilized resources and under-utilized resources and including a color-coded indication of utilization for each resource over a plurality of time periods including at least one predicted utilization for each resource in a future time period;
display the summary graphical report; and
display the utilization graphical report using a user interface that supports automated manipulation of information in the graphical report in response to a user interaction.
